(19) United States
(12) Patent Application Publication
(10) Pub. No.: US 2024/0383547 A1
(43) Pub. Date: Nov. 21, 2024

(54) PASS-THROUGH TENSIONING SYSTEM FOR CARGO SECUREMENT

(71) Applicant: A Wood Products LLC, Poway, CA (US)

(72) Inventors: Adam Wood, Poway, CA (US); Kevin Klemmt, Maple Valley, WA (US)

(21) Appl. No.: 18/668,081

(22) Filed: May 17, 2024

Related U.S. Application Data
(60) Provisional application No. 63/467,419, filed on May 18, 2023.

(51) Int. Cl. B62D 43/02; B62D 43/00

(52) U.S. Cl. CPC B62D 43/02; B62D 43/007

(57) ABSTRACT

Embodiments are directed toward a storage container. In some embodiments, the container includes a portable storage unit having a first opening configured to receive items to be removably stored and a second opening configured to receive the tensioner with the securing member disposed inside the portable storage unit. The proximal end portion of the tensioner has the securing member disposed internally to the storage unit while the distal end portion is configured to secure the portable storage unit to an external structure. The securing member is configured to prevent the proximal end portion of the tensioner from being pulled out of the portable storage unit through the second opening. Accordingly, the securing member being disposed inside the portable storage unit facilitates securing the portable storage unit closer to the structure.

### CROSS REFERENCE TO RELATED APPLICATION

This non-provisional application claims the benefit of the filing date of co-pending provisional application Ser. No. 63/467,419, filed May 18, 2023, entitled PASS-THROUGH TENSIONING SYSTEM FOR VEHICLE CARGO SECUREMENT, under 35 U.S.C. § 119, the entirety of which is hereby incorporated herein by reference.

### FIELD OF THE INVENTION

This application relates to structures for securing portable storage to other structures and, more particularly, to fixed structures or vehicles.

### BACKGROUND OF THE INVENTION

Overlanding is the practice of traveling over long distances for extended periods in a vehicle in remote areas. Participants must therefore provide for all their needs during an excursion. To increase the available storage convenience and capacity of a vehicle, some items may be fastened to the exterior of the vehicle, such as to a storage rack on the roof. Fastening on the exterior of the vehicle may aid in placing items in convenient locations for use and may also locate smelly or dirty items outside to avoid soiling the vehicle interior. The storage and accessibility issues also apply to other vehicle uses beyond overlanding.

Other locations for storing such items include mounting such items on a spare tire fixed to the rear of a vehicle. One such approach includes a bag commonly known as a “Trasharoo,” as shown in FIG. 1. The Trasharoo is a bag 10 with straps 14, 16 that crisscross behind the spare tire 12 to couple the bag 10 to the tire 12. The tension in the straps 14, 16 is adjusted through respective buckles 18, 20, that are typically disposed on the tire 12 while the straps 14, 16 crisscross behind the tire 12 or loop through openings in the wheel, between the hub and the rim. The bag 10 suffers from numerous problems. The bag 10 tends to droop relative to the tire 12, especially when loaded with items. Such drooping prevents tightly securing the bag 10 to the tire 12, which increases the jostling of the contents of the bag 10 while driving. Such drooping is especially problematic when overlanding because the transition from a steep decline to a flat surface requires increased clearance at the rearward portion of the vehicle. The bag 10 is also prone to theft. Moreover, when the spare tire 12 is coupled to a hinged mount 22 rearward of a rear vehicle door 24, the crisscrossed straps 14, 16 might prevent utilizing the hinged mount 22 to open the rear door 24 while the bag 10 is coupled to the tire 12.

It would be an advantage to provide additional options for external securement of items to fixed structures or vehicles.

It would also be an advantage to provide storage options that can be tightly secured to such structures or vehicles while being closely secured to such structures or vehicles.

It would be a further advantage to provide storage options that can be disposed at differing selectable heights relative to such structure or vehicle while maintaining the same tension between the storage option and the structure or vehicle.

It would also be advantage to provide storage options that can be secured to such structures or vehicles in a manner that deters theft.

It would be a further advantage to provide storage options that simplify mounting such storage options to spare tires while enabling utilization of hinged mounts for the spare tires without removing the storage option from such spare tires.

### SUMMARY OF THE INVENTION

It is therefore an object of the present invention to provide storage containers that facilitate securing items to fixed structures or vehicles.

It is also an object of the present invention to provide storage containers that achieve the above object and that may be tightly secured to such structures or vehicles while being positioned close to such structures or vehicles.

It is another object of the present invention to provide storage containers that achieve the above objects and wherein such containers may be positioned at different selectable heights relative to such structures or vehicles.

It is a further object of the present invention to provide storage containers that achieve the above objects and that deter theft.

The invention achieves the above objects, as well as other objects and advantages that will become apparent from the description that follows, by providing a storage container. The storage container has a portable storage unit, a tensioner, and a securing member. The portable storage unit has an opening that is configured to receive items to be stored in the storage unit, temporarily or longer term. The storage unit also has an opening that is configured to receive the tensioner with the securing member disposed in the storage unit. The distal end portion of the tensioner is configured to secure the portable storage unit to a structure external to such unit. In some embodiments, the structure is a vehicle or fixed object rigidly coupled to the vehicle. In other embodiments, the structure is another storage container, such as a storage container that is secured to a vehicle or fixed object rigidly coupled to the vehicle.

The securing member operates on the proximal end portion of the tensioner in the storage unit and is configured to prevent the proximal end portion of the tensioner from being pulled out of the portable storage unit through the second opening. Accordingly, the securing member being disposed inside the storage unit facilitate securing the portable storage unit closer to the structure, especially compared to a situation where the tensioner had an external tension adjuster disposed outside the portable storage unit between the storage unit and the structure.

In some embodiments, the securing member includes a tension adjuster. The tension adjuster operates on the proximal end portion of the tensioner in the storage unit and is configured to adjust the tension applied by the tensioner to the portable storage unit and the external structure. Accordingly, the tension adjuster being disposed inside the storage unit facilitates securing the portable storage unit close to the structure, especially compared to a situation where the tensioner was disposed outside the portable storage unit between the storage unit and the structure.

In some embodiments, the storage unit has a rigid or semi-rigid anchor that has one or more openings configured to receive the tensioner with the securing member being disposed in the storage unit. In some embodiments, the rigid or semi-rigid anchor facilitates the tensioner applying a large tension force to the storage unit without deforming the storage unit. In some embodiments, the openings of the anchor are each disposed at different heights and are configured to receive the tensioner with the securing member disposed in the portable storage unit. Accordingly, the user is able to adjust the height of the portable storage unit relative to the structure by selecting which opening in the anchor receives the tensioner. Moreover, the portable storage unit may be disposed the same distance from the structure with the same tension applied by the tensioner regardless of the height selected by the user.

In some embodiments, the portable storage unit is a bag. In other embodiments, the portable storage unit is a box. In some embodiments, the anchor is defined by a rigid or semi-rigid sheet, such as a sheet disposed in the bag or defining a rear wall of the bag. In other embodiments, the anchor is defined by a frame of the box or a wall of the box.

In some embodiments, the storage unit has an adjustable wall that the user can move to adjust the volume in the storage unit that is available for items to be stored. In some embodiments, the adjustable wall is adjustably coupled to the anchor. In some embodiments, a member extends from the adjustable wall through one of the openings in the anchor to adjustably couple the wall to the anchor. Accordingly, the user can adjust the position of the wall by inserting the member into a different one of the openings in the anchor.

In some embodiments, some of the openings in the anchor are slots. In some embodiments, some of the slots are disposed of different angles. Accordingly, the user may select different slots through which the tensioner extends based on the angle that the user selects for the tensioner to reside while the tensioner secures the storage unit to the structure.

The user may therefore insert the tensioner through the appropriate opening of the portable storage unit, couple the distal end portion of the tensioner to the structure, and, while the securing member is disposed in the storage unit, optionally adjust the tension applied by the tensioner by manipulating the tension adjuster. Accordingly, the user's hands have a large space in which to work compared to a situation in which an external tension adjuster was disposed between the storage unit and the structure.

### BRIEF DESCRIPTION OF THE DRAWINGS

The preferred embodiments of the present invention are described in detail below with reference to the following drawings:

FIG. 1 is a rear perspective view of a storage bag secured to a spare tire of a vehicle.

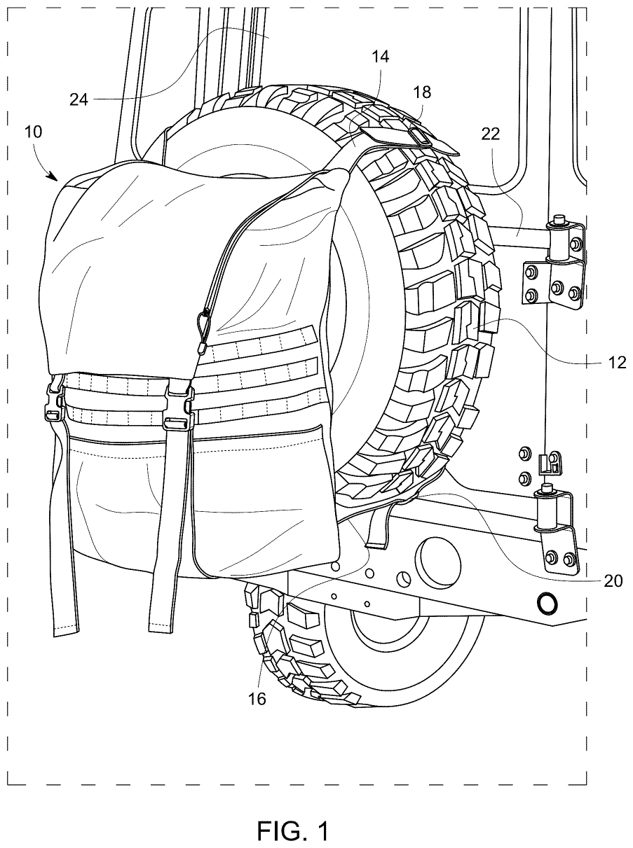

FIG. 2 is a right perspective view of a storage container in a closed configuration according to the principles of the invention.

FIG. 3 is a left perspective view of the storage container in FIG. 2.

FIG. 4 is an overhead perspective view of the storage container in FIG. 2.

FIG. 5 is a rear view of the storage container of FIG. 2 in an open configuration.

FIG. 6 is a perspective view of another storage container according to the principles of the invention.

FIG. 7 is a rear isometric view of the storage container in FIG. 6.

FIG. 8 is a front isometric view of the storage container in FIG. 6.

FIG. 9 is a top view of the storage container in FIG. 6.

FIG. 10 is a perspective view of a portion of a floor of the storage container in FIG. 6.

### DETAILED DESCRIPTION OF THE PREFERRED EMBODIMENTS

A storage container in accordance with the principles of the invention is generally indicated at reference members 40 and 182 in the Figures of the attached drawings, wherein numbered elements in the Figures correspond to like numbered elements herein.

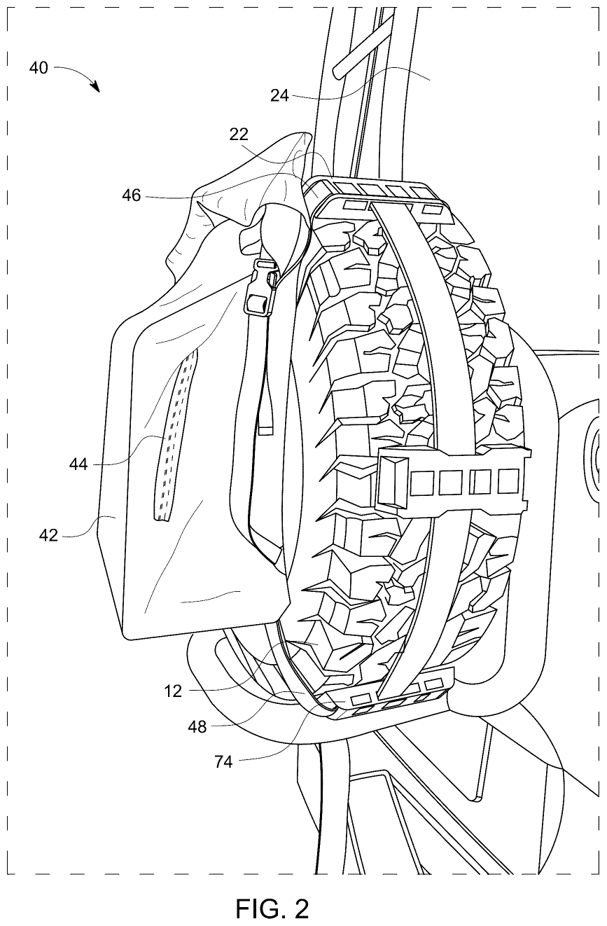

As shown in FIG. 2, the storage container 40 is configured to be coupled to a structure, such as a fixed structure or vehicle. In some embodiments, such structure may include the spare tire 12 adjacent the rear door 24 of the depicted vehicle.

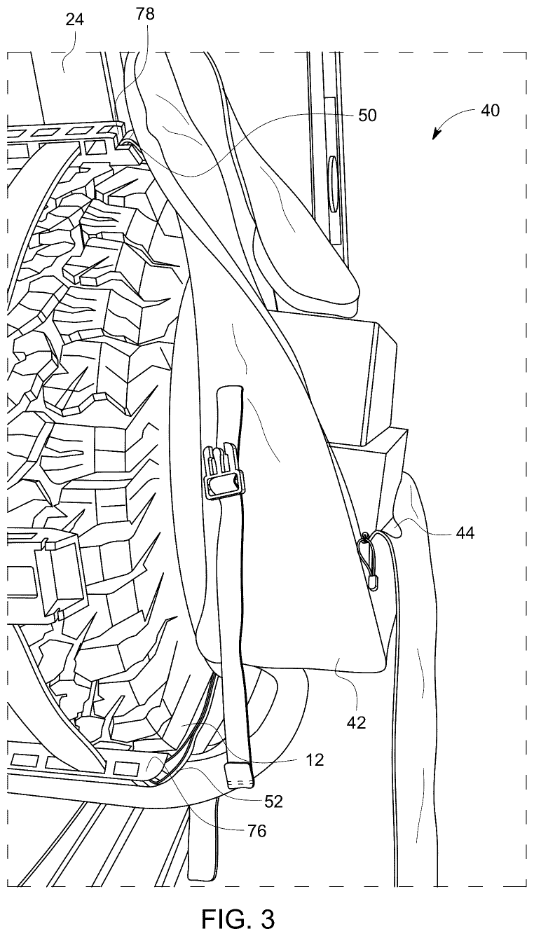

As shown in FIG. 3, the storage container 40 includes a portable storage unit, such as the bag 42, that has a first opening 44 configured to receive items to be removably stored in the portable storage unit 42, such as the wheel chocks shown in the drawing. As shown in FIGS. 2-4, the container 40 has a at least one tensioner, such as the tensioners 46-52, configured to secure the storage unit 42 to the structure external to the storage unit 42.

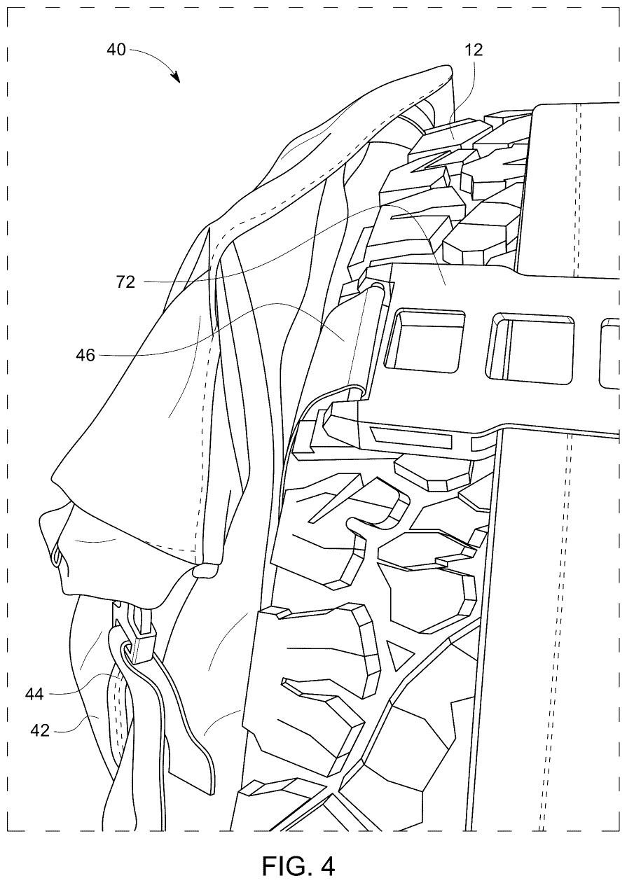

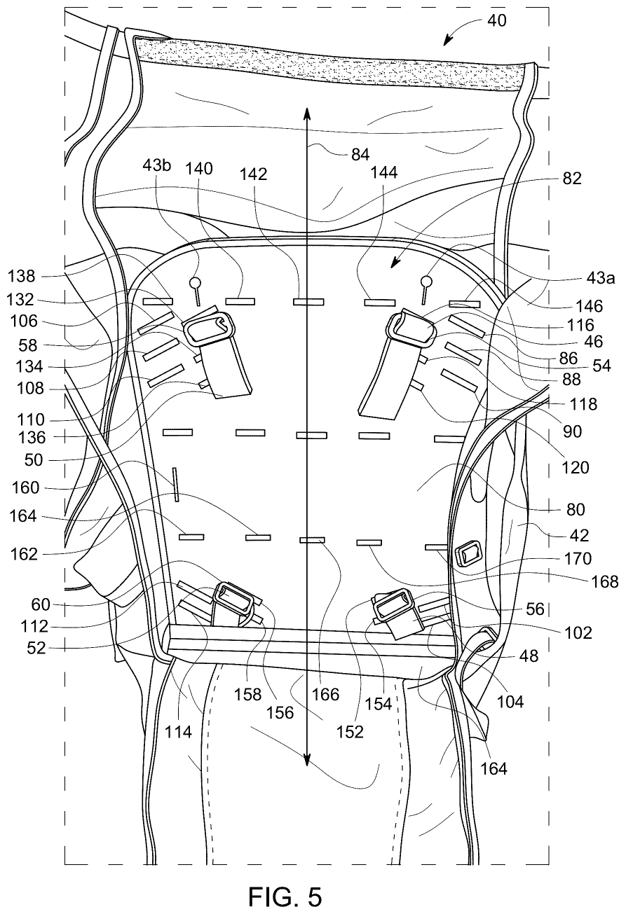

As shown in FIG. 5, the container 40 has at least one securing member for each tensioner, with such securing members being disposed inside the portable storage unit 42. The securing members shown FIG. 5 include a respective tension adjuster for each tensioner, such as the ladder lock buckles 54-62. The tension adjusters 54-62 facilitate adjusting the tension provided by a respective one of the tensioners between the structure and the storage unit 42. Importantly, at least one of the tension adjusters is disposed inside the portable storage unit 42. Accordingly, as shown in FIG. 4, disposing such tension adjuster inside the portable storage unit 42 facilitates increasing tension between the mounting point on the structure, such as one of the blocks 72-78, and the storage unit 42 while the storage unit 42 is closer to such mounting point than would otherwise enable increasing such tension if such tension adjuster were disposed outside the storage unit 42. This is accomplished by manipulating the tension with tension adjusters disposed inside the portable storage unit.

In other embodiments, however, at least one of the securing members does not include a tension adjuster and is instead fixedly coupled to its respective tensioner. For example, one or more of the securing members may include a washer or ring through which the tensioner extends, with the tensioner then being stitched into itself or otherwise around the washer or ring to fixedly couple the tensioner to the securing member. Such fixed securing member may then be passed through one of the openings in the portable storage unit 42 shown in FIG. 5 and rotated to prevent such fixed securing member from being pulled back out of the portable storage unit 42 when the tension through the tensioner is increased. The tension through such tensioner may be increased by a tension adjuster that is disposed outside the storage unit 42 and coupled to such tensioner. Alternatively, such tensioner may be devoid of a tension adjuster and may have a fixed effective length (i.e., the length of the portion of the tensioner securing member and the external structure is not adjustable). In such case, the distal end portion of such fixed-length tensioner may be coupled to the external structure, and the tension through such tensioner may thereafter be increased by manipulating a tension adjuster of another tensioner of the storage unit 42 (e.g., a tension adjuster having an adjustable effective length), which causes the portable storage unit 42 to pivot about the external structure and thereby increase tension through such tensioner of a fixed effective length. An advantage of such arrangement with fixed-length tensioners is apparent when the upper tensioners include fixed-length tensioners. In particular, such arrangement ensures that both the left upper tensioner and the right upper tensioner respectively cause and the left and the right sides of the storage unit 42 to be disposed at the same heights when inserted through openings in the storage unit 42 that are at the same height.

In some preferred embodiments, at least one wall or side of the storage unit 42 has at least one other opening that is configured to receive the proximal end portion of at least one of the tensioners 46-50 through such wall or side, as shown in FIG. 5. The distal end portion of each tensioner 46-50 is configured to secure the storage unit 42 to the external structure, such as by looping through a respective one of the blocks 72-78 as shown in FIGS. 2 and 3 or another mounting point on the structure. Appropriate mounting systems are disclosed in U.S. Pat. No. 11,752,949, titled MOUNTING SYSTEM FOR SECURING ITEMS TO A SPARE TIRE and issued to Wood et al. on Sep. 12, 2023, the entirety of which is hereby incorporated herein by reference.

In some embodiments, the storage unit 42 has a rigid or semi-rigid anchor, such as the rear wall 80 of the storage unit 42, that is configured to receive the proximal end portion of at least one of the tensioners 46-50 therethrough. As shown in FIG. 5, the rear wall 80 (i.e., anchor 80) is defined by a rigid or semi-rigid sheet that at least partially defines a wall of the storage unit 42. The sheet 80 (i.e., anchor 80) facilitates the tensioners 46-50 applying a large tension force without significantly deforming the storage unit 42. In particular, the securing members secure the tensioners to the anchor 80 from inside the portable storage unit 42 and enable thereafter increasing the tension on the tensioners to couple the storage unit 42 to the external structure.

In some embodiments, the sheet 80 includes plastic, rigid woven material, or metal. In some embodiments, this anchor sheet is separable from the storage unit 42 and removably couples thereto. Such coupling can be by hook-and-loop fasteners, snaps, or male protrusions received through a keyhole and slot arrangement such as the keyhole and slots 43a and 43b shown in FIG. 5. Alternatively, other mechanisms may be used such as tensioners extending from the storage unit 42 through the anchor in the same manner as described herein with respect to coupling the tensioners 46-50 to the anchor. In other embodiments, the anchor is fixedly secured to the storage unit 42, such as by stitching, friction welding, or other methods. In further embodiments, the anchor is integral to the storage unit 42, such as the storage unit 42 and the anchor being a unitary structure.

As shown in FIG. 5, the anchor 80 in some embodiments defines a plurality of openings 82 that are configured to receive the proximal end portion of at least one of the tensioners 46-50. In some embodiments, the anchor 80 defines each opening of the storage unit 42 and is configured to receive the proximal end portions of the tensioners 46-50. In other embodiments, another portion of the storage unit 42, such as fabric disposed forward of the anchor 80, defines at least one opening of the storage unit 42 that is configured to receive such proximal end portions while at least one of the openings 82 also receives the proximal end portions of the tensioners 46-50.

In some embodiments, at least some of the openings 82 are disposed at different heights relative to each other or relative to the central axis 84 of the portable storage unit 42, as shown in FIG. 5. The openings 82 include openings 86-90 and 102-114. The openings 86-90 are each disposed at different heights. Likewise, the openings 102 and 104 are each disposed at different heights, the openings 106-110 are each disposed at different heights, and the openings 112 and 114 are each disposed to different heights. Accordingly, such openings facilitate adjusting the height of the portable storage unit 42 relative to the structure while applying the same tension through the tensioners 46-50 by selecting different ones of the openings 82 through which to extend the tensioners 46-50.

Adjusting the height of the portable storage unit 42 is particularly helpful when the container 40 is coupled to the rear of a vehicle when overlanding because the amount of clearance required at the rear end of the vehicle increases when the vehicle transitions from a steep decline to a horizontal surface when traveling in the forward direction. Such adjustment also increases convenience for access to items stored in the unit 42, as well as the ability to center the container 40 or a load in the unit 42 on the structure, such as the vehicle tire. Moreover, such adjustment facilitates locating the container 40 above or below a load external to the container 40, such as the load on a hitch rack or a load on top of the structure such as the vehicle tire.

In some embodiments, at least some of the openings 82 are disposed at different angles relative to each other or relative to the central axis 84 of the portable storage unit 42. As shown in FIG. 5, the openings 82 are slots, and the tensioners 46-50 are straps. The angle of each of the slots 82 is defined by the orientation of the major axis of the slot relative to the central axis 84, such as measured in a clockwise direction. The slots 116-120 are disposed at different angles relative to the slots 132-136 and relative to the slots 138-146. The slots 152 and 154 are disposed at different angles relative to the slots 156 and 158, the left vertically oriented slot 160 and its symmetric counterpart on the right side 80 (not shown), and the slots 162-170. In some embodiments, some of the openings 82 are disposed at different angles relative to the central axis 84 than other ones of the openings 82 that are on the same side of the central axis 84 or that are in the same quadrant of the anchor 80, such as the slots 116-120 compared to the slots 144 and 146. The angle of each of the slots 82 is defined by the orientation of the major axis of the slot relative to the central axis 84, such as measured in a clockwise direction.

As shown in FIG. 5, the slots 86-90, 106-110, 116-120, and 132-136 are disposed at approximately 135°; the slots 102, 104, 112, 114, 152, 154, 156, and 158 are disposed at approximately 45°; the slots 138-146, 162-170, and the middle row (not numbered) are disposed at approximately 90°; and the slot 160 and its counterpart (not shown) symmetrically disposed about the central axis 84 are disposed at approximately 180°. Accordingly, such slots 82 being disposed at different angles relative to each other facilitates the tensioners 46-50 extending through respective ones of the slots 82 at different angles without the tensioners 46-50 having a significant torsion force applied thereto by the anchor 80 due to misalignment of the slots 82 and the width dimension of the tensioners 46-50. This avoids a twist in the tensioners that may occur depending on the angle imparted on the tensioner strap by the vehicle member to which the straps may be secured and the angle of the strap from such member to the anchor.

In some embodiments, the storage unit 42 has a rigid or semi-rigid floor, such as the floor 164 shown in FIG. 5, to reduce sag or deformation of the portable storage unit 42, shown in FIG. 3. In some embodiments, the floor 164 includes the same material as the anchor 80. As shown in FIG. 5, the floor 164 is rigidly coupled to the anchor 80 or forms a unitary structure with the anchor 80. In other embodiments, the floor 164 is separate from or removably coupled to the anchor 80.

As shown in FIGS. 2-5, the storage opening 44 is configured to transition between a closed configuration (FIG. 2) and an open configuration (FIG. 3) by translating a clasp locker or zipper. As also shown in those Figures, the upper-end portion of the opening 44 in the closed configuration is covered with a waterproof or water resistant roll top (FIG. 2). Accordingly, in some embodiments, the portable storage unit 42 defines a waterproof or water resistant bag.

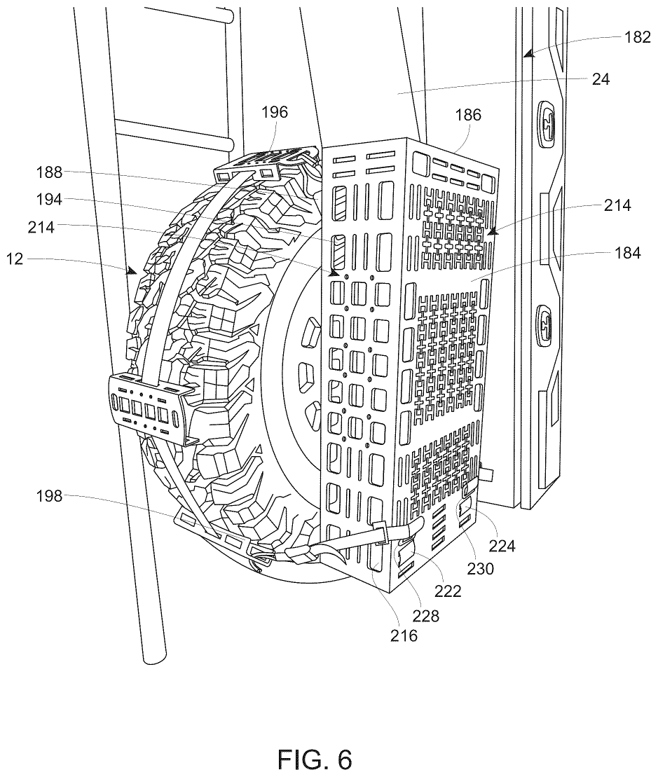

In other embodiments, the anchor panel of the portable storage unit includes a frame or cage. As shown in FIG. 6, the container 182 is also configured to be coupled to a structure, such as a fixed structure (e.g., the spare tire 12) or vehicle. The storage container 182 includes a portable storage unit, such as the frame or cage 184, that has a first opening 186 configured to receive items to be removably stored in the portable storage unit 184. Preferably, the container 182 has at least one tensioner, such as the upper tensioners 188 and 190 and lower tensioners (not shown, but operatively and structurally the same as the tensioners 48 and 52), configured to secure the storage unit 184 to the external structure.

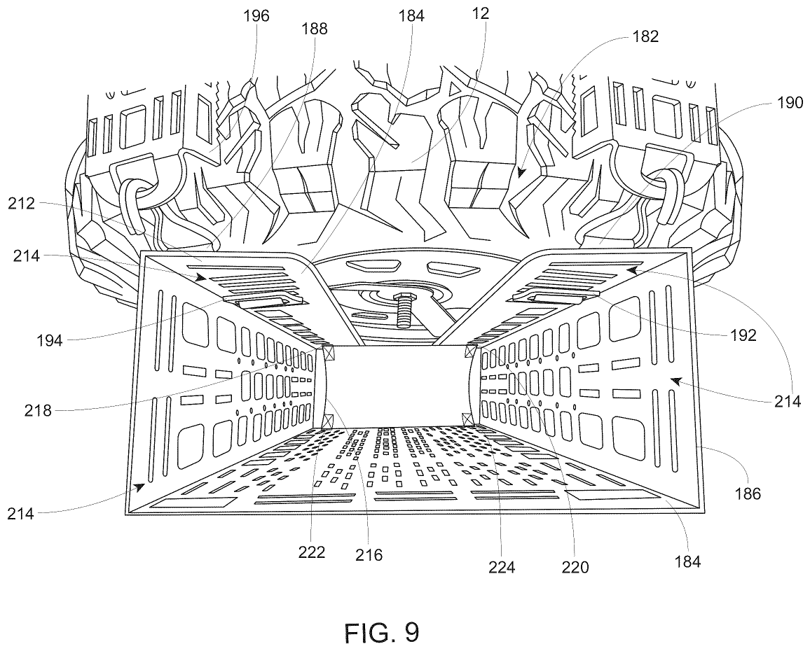

As shown in FIGS. 6 and 9, container 182 has at least one securing member, preferably including one or more respective tension adjusters for at least some of the tensioners, such as the latter lock buckles 192 and 194 and lower tension adjusters (not shown, but operatively and structurally the same as the tension adjusters 54 and 60). Such securing members operate in the same manner as described with respect to the container 40. In particular, at least one of the securing members is disposed inside the portable storage unit 184. Accordingly, as shown in FIGS. 6 and 9, disposing such tension adjuster inside the portable storage unit 184 facilitates increasing tension between the mounting point on the structure, such as one of the blocks 196 and 188, and the storage unit 184 while the storage unit 184 is closer to such mounting point than would otherwise enable increasing such tension if such tension adjuster were disposed outside the storage unit 184, as discussed above regarding container 40.

In particular, as described above regarding the container 40, at least one wall or side of the storage unit 184 has at least one opening that is configured to receive the proximal end portion of at least one of the tensioners through such wall or side, as shown in FIG. 6. The distal end portion of each tensioner (whether implemented with the container 40 or storage unit 184) is configured to secure the storage unit to the external structure. This can be accomplished, for example, by hooking in a respective one of the blocks 196, 198 as shown in FIG. 6 or another mounting point on the structure. The storage unit 184 may also implement the securing method described above with respect to storage unit 42, such as looping through the block.

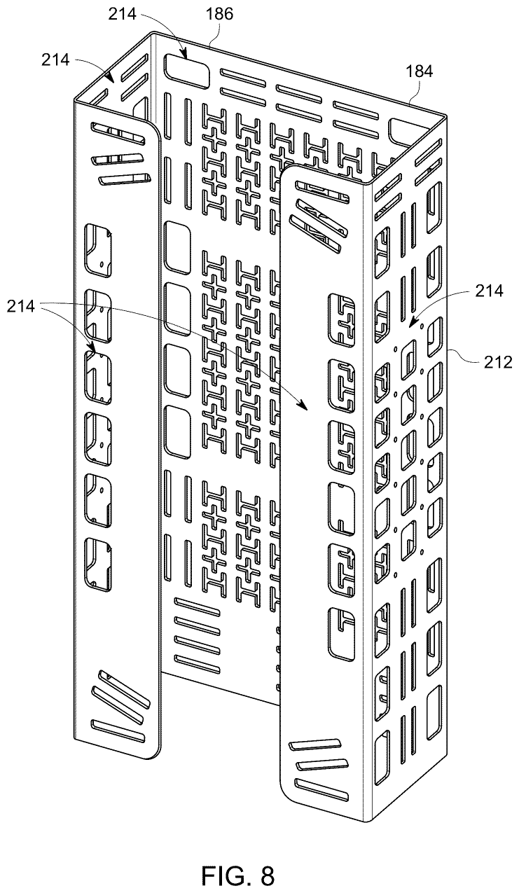

In some embodiments, the storage unit 184 has a rigid anchor, such as the frame or cage 212 that defines the storage unit 184, that is configured to receive the proximal and portion of at least one of the tensioners therethrough, as shown in FIGS. 6 and 9. In some embodiments, the cage 184 includes plastic, metal, or wood. As shown in FIGS. 6-10, the rigid anchor 212 in some embodiments defines a plurality of openings 214 that are configured to receive the proximal end portion of at least one of the tensioners. In some embodiments, at least some of the openings 214 are disposed at different heights, angles, or lateral positions, as shown and described above with respect to the openings 82 of the anchor 80.

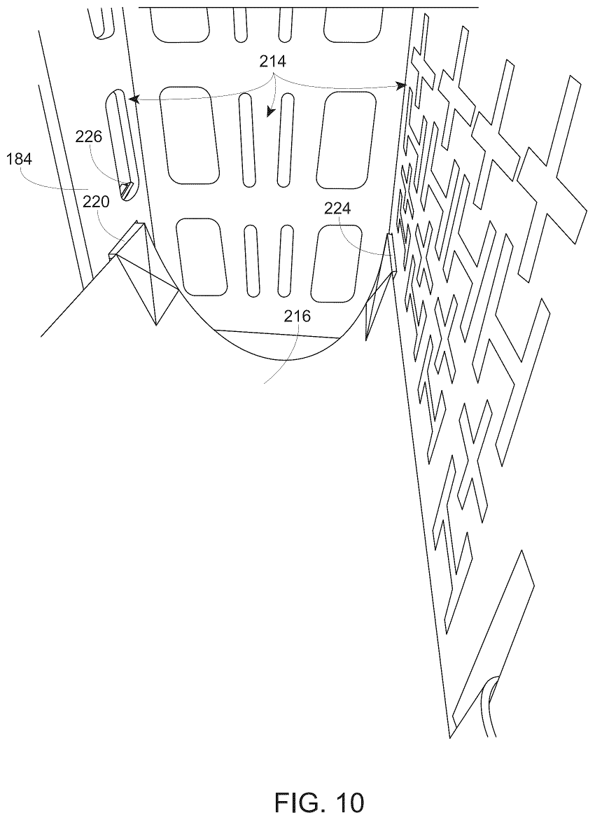

In some embodiments, storage unit 184 has at least one adjustable wall, such as the floor 216 shown in FIGS. 9 and 10, that is preferably coupled to the rigid anchor 212. Accordingly, the usable interior volume of the storage unit 184 is modifiable by changing the position of the adjustable wall relative to the remainder of the rigid anchor 212. As shown in FIGS. 9 and 10, lowering the position of the floor 216 increases the portion of the interior volume of the storage unit 184 that is available to receive items for storage (i.e., the effective volume available in the storage unit 184). Raising the position of the floor 216 decreases the effective volume available in the storage unit 184 but may better position the items to be stored for easy access. As shown FIGS. 9 and 10, the adjustable wall 216 couples to the rigid anchor 212 with at least one (e.g., four as shown in FIG. 9) securing member, such as a tension adjuster. For example, at least one tensioner may extend from the adjustable wall 216 through a respective one of the openings 214. A respective securing member is disposed opposite the rigid anchor 212 from the adjustable wall 216. This enables securement of the adjustable wall 216 to the rigid anchor 212 at selectable positions according to the positions of the various openings 214.

Each container 40, 182 is configured to be secured to another storage container having one or more elements, functions, or features of one or more of the containers 40, 182. Accordingly, in some embodiments, the external structure may be such a container, and the container 40, 182 may be disposed internal to or external to such other container while such other container is coupled to a vehicle or a rigid structure, such as the tire 12.

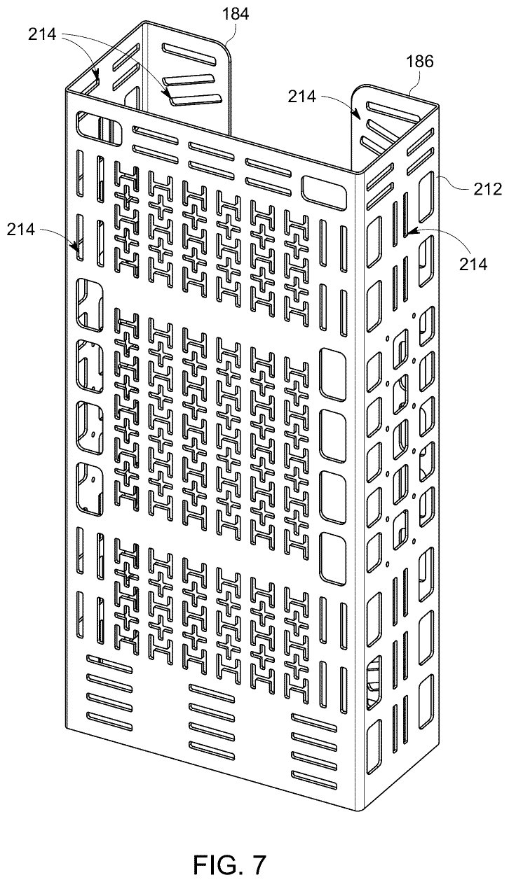

As shown in FIGS. 7-9, the front wall of the storage unit 184 includes two separate wall components. Accordingly, the storage unit 184 and the cage 212 may not entirely enclose the interior volume that is configured to receive items for storage. In other embodiments, the front wall of the storage unit 184 is defined by a unitary structure that extends along the entirety of the front of the storage unit 184. In either case, the storage unit 184 shown in FIG. 6 is a box while the rigid frame 212 shown in FIG. 6-9 is a frame of the box or defines a wall of the box.

As used herein, the following terms take the meanings explicitly associated herein, unless the context clearly dictates otherwise. The terms “front,” “forward,” “rear,” and “rearward” are defined relative to the direction of the external structure to which the container is configured to couple while such container is secured to the external structure. The terms “front” and “forward” indicate the direction from the container toward the external structure while the container is secured to the external structure. The terms “rear” and “rearward” indicate the direction from the external structure toward the container while the container is secured to the external structure. The terms “height,” “vertical,” “upper,” “lower,” “above,” “below,” “top,” “bottom,” “topmost,” and “bottom-most” are defined relative to vertical axis of the container when it is oriented in the manner shown in FIGS. 2 and 6. The vertical axis is defined as parallel to the direction of the earth's gravity force on the container when the container is in the orientation shown in FIGS. 2 and 6. The term “lateral” is defined relative to the lateral axis of the container. The lateral axis is non-parallel to the longitudinal and vertical axes and thus the central axis 84.

The term “configured” as used herein means an element being one or more of sized, dimensioned, positioned, or oriented to achieve or provide the recited function or result. The term “directly coupled” as used herein means that a component contacts (for example, when bolted) or is welded to another component. The term “indirectly coupled” as used herein means that a first component is coupled to a second component by way of one or more intervening components that are directly coupled to the first and second components. A first component that is indirectly coupled to a second component is directly coupled to a third component, which may be directly coupled to the second component or to a fourth component that is directly coupled to the second component. The term “coupled” should therefore be understood to disclose both direct and indirect coupling of components or elements that are described as being coupled to each other.

The term “substantially parallel” refers to parallel or within 5, 10, 15, or 20 degrees of parallel. The term “substantially orthogonal” refers to orthogonal or within 5, 10, 15, or 20 degrees of orthogonal. The term “substantially horizontal” or “substantially horizontally” refers to horizontal or within 5, 10, 15, 20, 25, or 30 degrees of horizontal. The term “substantially vertical” or “substantially vertically” refers to vertical or within 5, 10, 15, 20, 25, or 30 degrees of vertical. The term “approximately” or “substantially” refers to within 1, 5, 10, 15, 20, 25, 30, 40, or 50 percent of the identified value or range.

The term “or” is an inclusive grammatical conjunction to indicate that one or more of the connected terms may be employed. For example, the phrase “one or more A, B, or C” or the phrase “one or more As, Bs, or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” as used herein is not exclusive and allows for being based on additional factors not described. The articles “a,” “an,” and “the” include plural references. Plural references are intended to also disclose the singular.

While the preferred embodiments of the invention have been illustrated and described, as noted above, many changes can be made without departing from the spirit and scope of the invention. Each disclosure of a component preferably having a feature or characteristic is intended to also disclose the component as being devoid of that feature or characteristic unless the principles of the invention clearly dictate otherwise. For example, any of the elements, functions, or features of the container 40 or its subcomponents may be implemented with or replaced by any of the elements, functions, or features of the container 182 or its subcomponents. Accordingly, the scope of the invention is not limited by the disclosure of the preferred embodiment. Instead, the invention should be determined entirely by reference to the claims that follow. It should also be noted that the claim dependencies or combinations of elements recited in the claims do not reflect an intention to forgo claiming other subject matter disclosed herein. Instead, this disclosure is intended to also disclose the subject matter of any combination of any two or more of the claims, such that subsequent claim sets may recite that any one of the dependent claims depends from any other one or more claims, up to and including all other claims in the alternative (such as “The apparatus or method of any one of the preceding or subsequent claims . . . ”). This disclosure is also intended to disclose the subject matter of any one of the dependent claims, as if it were an independent claim, with or without all or a portion of the subject matter of the original independent claim(s) or any other subject matter disclosed herein.

Those of ordinary skill in the art will conceive of other alternate embodiments of the invention upon reviewing this disclosure. Thus, the invention is not to be limited to the above description but is to be determined in scope by the claims that follow.

1. A storage container, comprising:
a tensioner having a proximal end portion and a distal end portion, the proximal end portion having a securing member; and
a portable storage unit having a first opening and a second opening, the first opening being configured to receive items to be removably stored in the portable storage unit, the second opening being configured to receive the tensioner with the securing member disposed inside the portable storage unit,
wherein the distal end portion of the tensioner is configured to secure the portable storage unit to an external structure,
wherein the securing member is configured to prevent the proximal end portion of the tensioner from being pulled out of the portable storage unit through the second opening, whereby the securing member being disposed inside the portable storage unit facilitates securing the portable storage unit closer to the structure than the portable storage unit would be disposed if the tensioner had an external tension adjuster disposed outside the portable storage unit and between the portable storage unit and the structure.

2. The storage container of claim 1, wherein the securing member includes a tension adjuster, and the tension adjuster is configured to adjust the tension applied to the portable storage unit and the structure by the tensioner, whereby the tension adjuster being disposed inside the portable storage unit facilitates securing the portable storage unit closer to the structure than the portable storage unit would be disposed if the tension adjuster were disposed outside the portable storage unit and between the portable storage unit and the structure.

3. The storage container of claim 1, wherein the storage unit has an anchor that defines the second opening.

4. The storage container of claim 1, wherein the storage unit has a rigid or semi-rigid anchor that defines a plurality of openings that are each disposed at different heights relative to the anchor and that are configured to receive the tensioner with the securing member disposed inside the portable storage unit, whereby the plurality of openings defined by the anchor facilitate adjusting the height of the portable storage unit relative to the structure by selecting which opening in the plurality of openings receives the tensioner while enabling the portable storage unit to be disposed the same distance from the structure with the same tension applied to the portable storage unit and the structure by the tensioner regardless of which opening in the plurality of openings receives the tensioner.

5. The storage container of claim 1, wherein the storage unit has a rigid or semi-rigid anchor that defines the second opening, the portable storage unit is a bag, and the rigid anchor is a rigid sheet disposed in the bag.

6. The storage container of claim 1, wherein the storage unit has a rigid anchor that defines the second opening, the portable storage unit is a box, and the rigid anchor is a frame of the box or is a wall of the box.

7. The storage container of claim 1, wherein the storage unit has a rigid anchor that defines the second opening, wherein the storage unit has an adjustable wall that is adjustably coupled to the rigid anchor such that an effective volume available in the storage unit for the items to be stored is modified by changing a position of the adjustable wall relative to the rigid anchor.

8. The storage container of claim 1, wherein the storage unit has an adjustable wall and a rigid anchor that defines a plurality of openings that includes the second opening, wherein the adjustable wall adjustably couples to the rigid anchor with a member extending through a selected one of the plurality of openings defined by the rigid anchor, thereby facilitating modifying the position of the adjustable wall relative to the rigid anchor by selecting a different opening in the plurality of openings through which to extend the member.

9. The storage container of claim 1, wherein the storage unit has a rigid or semi-rigid anchor that defines a plurality of openings that includes the second opening, wherein two or more openings in the plurality of openings are slots disposed at different angles relative to a central axis of the anchor to facilitate the tensioner securing the storage unit to the structure while the tensioner is disposed at different angles when received through a different selected one of the two or more openings.

10. The storage container of claim 1, wherein the external structure is another storage container.

11. The storage container of claim 10, wherein the other storage container is coupled to a vehicle or fixed object rigidly coupled to the vehicle.

12. A method of securing a storage container, comprising:
providing a storage container that includes:
a tensioner having a proximal end portion and a distal end portion, the proximal end portion having a securing member; and
a portable storage unit having a first opening and a second opening, the first opening being configured to receive items to be removably stored in the portable storage unit,
inserting the tensioner through the second opening of the portable storage unit;
coupling the distal end portion of the tensioner to the external structure;
while the securing member is disposed inside the portable storage unit and the tensioner extends through the second opening of the portable storage unit, manipulating the securing member to prevent the distal end portion of the tensioner from being pulled out of the portable storage unit through the second opening,
whereby manipulating the securing member while the securing member is disposed inside the portable storage unit facilitates securing the portable storage unit closer to the structure than the portable storage unit would be disposed if the tension adjuster had an external tension adjuster disposed outside the portable storage unit and between the portable storage unit and the structure.

13. The method of claim 12, wherein the securing member includes a tension adjuster, the tension adjuster is configured to adjust the tension applied to the portable storage unit and the structure by the tensioner, and manipulating the securing member includes manipulating the tension adjuster to adjust the tension applied to the portable storage unit and the structure by the tensioner, whereby manipulating the tension adjuster while the tension adjuster is disposed inside the portable storage unit facilitates securing the portable storage unit closer to the structure than the portable storage unit would be disposed if the tension adjuster were disposed outside the portable storage unit and between the portable storage unit and the structure.

14. The method of claim 12, wherein the storage unit has a rigid or semi-rigid anchor, and inserting the tensioner through the second opening includes inserting the tensioner through the anchor.

15. The method of claim 12, wherein the storage unit has a rigid or semi-rigid anchor that defines a plurality of openings that are configured to receive the tensioner with the securing member disposed inside the portable storage unit, the openings in the plurality of openings each being disposed at different respective heights on the anchor,
wherein inserting the tensioner through the second opening includes:
while the portable storage unit is secured to the structure at a first height relative to the structure with the tensioner disposed in a first selected opening in the plurality of openings that corresponds to the first height, manipulating the securing member to enable the distal end portion of the tensioner to be pulled through the first selected opening in the plurality of openings and out of the portable storage unit;
removing the tensioner from the first selected opening in the plurality of openings;
selecting a second height of the storage unit relative to the structure, the second height being different than the first height; and
inserting the tensioner through a second selected opening in the plurality of openings that corresponds to the second height of the storage unit, the second opening being the second selected opening in the plurality of openings,
whereby the openings in the plurality of openings each being disposed at the different respective heights on the rigid anchor facilitates adjusting the height of the portable storage unit relative to the structure while enabling the portable storage unit to be disposed the same distance from the structure with the same tension applied to the portable storage unit and the structure by the tensioner regardless of which opening in the plurality of openings receives the tensioner.

16. The method of claim 12, further comprising:
selecting a wall of the storage unit that is adjustably coupled to a rigid or semi-rigid anchor of the storage unit, the anchor defining the second opening; and
modifying an effective volume available in the storage unit for the items to be stored by changing a position of the wall relative to the anchor.

17. The method of claim 12, further comprising:
selecting a wall of the storage unit that is adjustably coupled to a rigid anchor of the storage unit, wherein the rigid anchor defines the second opening, wherein the wall adjustably couples to the rigid anchor with a member extending through a selected one of the plurality of openings defined by the rigid anchor; and
modifying an effective volume in the storage unit for the items to be stored by inserting the member through a different selected one of the plurality of openings defined by the rigid anchor to change a position of the wall relative to the rigid anchor.

18. The method of claim 12, wherein the storage unit has a rigid anchor that defines a plurality of openings that includes the second opening, at least a first opening in the plurality of openings and the second opening being slots disposed at different angles relative to a central axis of the rigid anchor,
wherein inserting the tensioner through the second opening includes:
while the portable storage unit is secured to the structure with the tensioner disposed at a first angle relative to a central axis of the rigid anchor and extending through a first opening in the plurality of openings that corresponds to the first angle, manipulating securing member to enable the distal end portion of the tensioner to be pulled through the first opening in the plurality of openings and out of the portable storage unit;
removing the tensioner from the first opening in the plurality of openings;
selecting a second angle relative to the central axis of the rigid anchor for the tensioner to be disposed while the portable storage unit is secured to the structure, the second angle being different than the first angle; and
inserting the tensioner through a second selected opening in the plurality of openings that corresponds to the second angle, the second opening being the second selected opening in the plurality of openings,
wherein the first selected opening is a first slot having a major axis that extends substantially perpendicular to the first angle, and the second selected opening is a second slot having a major access that extends substantially perpendicular to the second angle,
whereby the first slot and the second slot being disposed at different angles facilitates the tensioner securing the storage unit to the structure while the tensioner is disposed at different angles relative to the rigid anchor.

19. The method of claim 12, wherein the external structure is another storage container.

20. The method of claim 19, wherein the other storage container is coupled to a vehicle or fixed object rigidly coupled to the vehicle.
